(19) United States
(12) Patent Application Publication
(10) Pub. No.: US 2013/0220175 A1
(43) Pub. Date: Aug. 29, 2013

(54) RECYCLED ASPHALT PAVING FORMULATION AND METHOD OF MAKING SAME

(71) Applicant: Recycled Asphalt Shingle Technology, (US)

(72) Inventor: Thomas J. Zickell, New Castle, NH (US)

(73) Assignee: Recycled Asphalt Shingle Technology, Brentwood, NH (US)

(21) Appl. No.: 13/680,619

(22) Filed: Nov. 19, 2012

Related U.S. Application Data
(63) Continuation-in-part of application No. 13/495,477, filed on Jun. 13, 2012.
Application No. 13/495,477 is a continuation-in-part of application No. 12/845,179, filed on Jul. 28, 2010.
(60) Provisional application No. 61/560,987, filed on Nov. 17, 2011.
(60) Provisional application No. 61/659,127, filed on Jun. 13, 2012.

(51) Int. Cl. C08L 95/00

(52) U.S. Cl. CPC C08L 95/00
USPC 106/273.1

(57) ABSTRACT

An asphalt paving mixtures suitable for roadway paving is formulated by mixing very soft penetration asphalt having a penetration value on the order of 300 to 400 and a melt point of 110° F. with recycled or reclaimed asphalt roofing shingles and/or recycled or reclaimed asphalt pavement granule material having a much higher melt point and a much lower penetration value. 10% to 30% of the recycled or reclaimed asphalt material in the final mixture will bring the formulation into compliance with PG grade paving asphalt. The asphalt paving mixture may utilize recycled asphalt shingle granules of approximately 50 mesh in size and preferably between 10 and 50 mesh while a powder may be utilized that is sized below 50 mesh.

### CROSS-REFERENCE TO RELATED APPLICATIONS

This application claims priority from U.S. Provisional Patent Application No. 61/560,987 entitled “Paving Asphalt Formulation And Method of Making Same”, filed on Nov. 17, 2011 and U.S. Provisional Patent Application No. 61/659,127 entitled “Horizontal Mixer”, filed on Jun. 13, 2012, which is a continuation-in-part of U.S. patent application Ser. No. 13/495,477 entitled “ASPHALT MATERIAL RECYCLING SYSTEM AND METHOD WITH BALL SCREENER AND IMPACT AND CUTTING CHOPPERS”, filed on Jun. 13, 2012, which is a continuation-in-part of U.S. patent application Ser. No. 12/845,179 entitled “Asphalt Material Recycling System and Method”, filed on Jul. 28, 2010, all of which are incorporated fully herein by reference.

### TECHNICAL FIELD

The present invention relates to paving asphalt and more particularly, relates to a method of formulating recycled paving asphalt utilizing reclaimed or recycled asphalt shingles and/or reclaimed or recycled asphalt pavement material.

### BACKGROUND INFORMATION

In the paving industry, the federal government and State Department of Transportation authorities grade asphalt for use in federal and state paving projects using a PG grading system. For example, the grade used in the State of New Hampshire is 64-28. In laymen's terms, this grade means that if the road surface is at 64°, it will not “rut” due to the weight of traffic. The second number, −28, indicates that the asphalt won't crack until the temperature drops below −28°. Only the asphalt is tested. Moreover, state and/or federal standards often define the maximum allowed recycled materials which may be included in road asphalt mixtures. For example, the New Hampshire Department of Transportation specifications permit 0.8% of a recycled binder with 0.6% of which can come from recycled roofing shingles.

The normal flux asphalt used by the paving industry is very hard, having a penetration value of approximately 100 and a melt point of approximately 100° F. The penetration value is tested by dropping a weighted needle on a slide apparatus into asphalt that is in its solid-state, at a certain temperature. The depth that the needle penetrates is measured.

Unfortunately however, virgin flux asphalt is rather expensive. Some prior art attempts have been made at substituting several ingredients for virgin asphalt in road paving asphalt. Most of these substitutes have not been favorably received or even successful at providing a road surface that meets various State and Federal standards while also producing a product that can be worked with and which is reduced enough in cost to justify the recycling process.

Accordingly, what is needed is a novel asphalt road paving formulation which is less expensive to make by replacing virgin flux asphalt with recycled asphalt material, but still meets the asphalt grading system required by the paving industry.

### DETAILED DESCRIPTION OF THE PREFERRED EMBODIMENTS

The present invention results, in part, from the realization that ground post consumer asphalt shingles can be added to very soft penetration asphalt (300-400 penetration, 110° F. melt point) to create an asphalt blend that meets PG grades for paving asphalt.

Asphalt shingle recycling processes are disclosed in, for example, U.S. Pat. Nos. 5,848,755, 5,938,130, and 6,290,152 by the inventor of the present invention and fully incorporated herein by reference. The recycling systems disclosed in the referenced patents are capable of recycling asphalt roofing material and reducing granules, cellulose and fiberglass fibers and other particles in the asphalt roofing material to a fine mesh that can be maintained in suspension in liquid asphalt for later reuse, such as in the present application.

Starting with such very soft penetration virgin asphalt, the method of the present invention adds either raw post-consumer recycled asphalt shingles or more preferably, recycled new and/or used roofing shingles in suspension, as disclosed in the patents mentioned above for example, or recycled or reclaimed asphalt pavement material. Recyclable asphalt material such as post-consumer asphalt shingles typically are very abundant and readily available since asphalt roofing shingles stripped from the roof of houses and other structures as well as perhaps rejected or left-over shingles from the asphalt roofing shingle manufacturing process are abundant.

Old roofing shingles, in particular, have a combination of two asphalt's: the first a 230 melt point, 12 penetration “coating” asphalt; and the second, a 140 melt point, 30 penetration “saturant” asphalt. Both asphalts are “oxidized” to raise the melt point so that the asphalt will not run off a roof during conditions of high heat conditions.

Asphalt has four major components: aromatics, saturates, resins and aspheltenes. The oxidation process drives out the lighter constituents in the asphalt that is, the aromatics. Moreover, when an asphalt roofing shingle ages, the aromatics and resins become aspheltenes which are solids. This is why old roofing shingles are brittle.

Accordingly, when starting with a very soft penetration virgin flux asphalt (300-400 penetration, 110° F. melt point) which has approximately 50% aromatics, the soft asphalt rebalances the old asphalt contained in the recycled asphalt roofing shingles (or recycled or reclaimed asphalt based pavement material) by re-supplying the lost aromatics and lower molecular compounds previously lost in the roofing shingles. The harder penetration recycled roofing shingle asphalt mixes with the very soft penetration new flux asphalt to create a blended asphalt that will meet PG grades for paving asphalt. Presently, it appears that between 20 to 30% ground roofing shingles will meet PG grade 64-28. Further, the cellulose fibers found in old shingles help to prevent cracking in the reformulated asphalt mixture.

Currently, recycled or reclaimed asphalt shingles are generally shredded or ground to a ⅜th inch maximum nominal size chip. These chips create another substantial problem, however. Roofing shingles are reinforced with either Fiberglas mat or an absorbent paper. These additional products cannot be avoided through separation because the waste stream is co-mingled either from individual roofs or at collection sites.

The present invention, however, contemplates that reclaimed asphalt shingles are ground to a maximum nominal size of a number 16 sieve size, which is subsequently separated into granules that are above 50 mesh size and powder below 50 mesh size but above 10 mesh size. By separating the reclaimed asphalt shingles into these 2 graduations, the plus 50 mesh product (granules) has reduced fines content, making it ideal for use as a recycled aggregate in hot mix asphalt, while the below 50 mesh material can also be used in recycled the asphalt paving applications as well as other applications.

For example, it has been found that adding approximately 5.2% virgin asphalt to a mixture containing 0.6% recycled asphalt shingle granules with a mesh size at or slightly above 50 mesh yielded a very usable recycled asphalt pavement material which passes New Hampshire Department of transportation requirements. Similarly, adding slightly more virgin asphalt content of approximately 5.3% with 0.6% recycled asphalt shingle powder of below 50 mesh size also yields an acceptable mixture. This is in contrast to prior art attempts at utilizing ground shingle chips in recycled asphalt paving compositions which required on the order of at least 5.7% virgin asphalt thus making the mixture much more expensive to produce.

Additional material or additives such as talc (in the range of 4% to 12% with 6% to 8% being a typical range) may be added to bind to the sticky exposed edges of the asphalt. For example, the granules may be coated with a mixture of approximately 65 percent limestone and 35 percent coating asphalt. The “coating” makes up about 30 percent of the mass of the material. Moreover, as mentioned herein, reclaimed or recycled asphalt pavement may also be utilized.

Modifications and substitutions by one of ordinary skill in the art are considered to be within the scope of the present invention, which is not to be limited except by the allowed claims and their legal equivalents.

The invention claimed is:

1. An asphalt paving mixture suitable for roadway paving containing recycled asphalt material, the asphalt paving mixture comprising, at least:
a quantity of virgin asphalt in the range of 5% to 5.5%; and
a quantity of recycled asphalt material accounting for approximately 0.6 percent of the finished mixture, said recycled asphalt material selected from the group consisting of recycled asphalt material granules having a size of approximately 50 mesh or slightly above and recycled asphalt material powder having a size significantly below 50 mesh and approximately 10 mesh.

2. The asphalt paving mixture of claim 1, wherein said recycled asphalt material granules are coated with a mixture comprising 65% limestone and 35% coating asphalt.

3. Asphalt paving mixture of claim 2, wherein said coating comprises approximately 30% of the mass of each of said granules.

4. A method of making an asphalt paving mixture containing recycled asphalt material, the method comprising the acts of:
mixing very soft penetration virgin or similar asphalt having a penetration value on the order of 300 to 400 and a melt point of approximately 110° F. with 10% to 30% of recycled asphalt roofing shingle or recycled asphalt pavement material having a much higher melt point and a much lower penetration value, wherein the recycled asphalt roofing shingle material includes granules having a size of approximately 50 mesh or above or a recycled asphalt roofing shingle material powder having a size significantly below 50 mesh and approximately 10 mesh.

5. The method of claim 4, wherein said recycled asphalt material granules are coated with a mixture comprising approximately 65% limestone and 35% coating asphalt, and wherein said coating comprises approximately 30% of the mass of each of said granules.
